(19) United States
(12) Patent Application Publication
(10) Pub. No.: US 2023/0184488 A1
(43) Pub. Date: Jun. 15, 2023

(54) CARRY BOX WITH INTEGRATED INDUCTION HEATER FOR ANNULAR BEARING COMPONENT COMPRISING A TOP BOX

(71) Applicant: Aktiebolaget SKF, Göteborg (SE)

(72) Inventors: Alberto Javier HERRERA CABALLERO, Utrecht (NL); Mitrut ILIE, Brasov (RO); Jiaji ZHAO, Delft (NL)

(21) Appl. No.: 17/988,952

(22) Filed: Nov. 17, 2022

(30) Foreign Application Priority Data
Dec. 13, 2021 (DE) 102021214235.4

(51) Int. Cl. F27B 14/06; C21D 9/40; F27B 14/20

(52) U.S. Cl. CPC F27B 14/061; C21D 9/40; F27B 14/20

(57) ABSTRACT

A carry box with integrated induction heater for an annular bearing component includes: a heater body providing an induction heater, a top surface to place an annular bearing component, and an inductor having two rods protruding outwardly with respect to the top surface, a top box having a closing lid and a bottom tray, the bottom tray being removably attached to the heater body and being destined to cover the top surface of the heater body in the attached position, the bottom tray being provided with at least one pocket, and a yoke intended to be stored into the pocket and intended to be placed on the two rods in use.

### CROSS-REFERENCE TO RELATED APPLICATIONS

This application claims priority to German Patent Application no. 102021214235.4, filed Dec. 13, 2021, the contents of which is fully incorporated herein by reference.

### TECHNICAL FIELD OF THE INVENTION

The present invention generally relates to the heating of annular bearing components. An annular bearing component relates to a bearing provided with rolling elements, typically balls or rollers, arranged between an inner bearing ring and an outer bearing ring. An annular bearing component can also relate to a plain bearing without rolling elements. An annular bearing component can further relate to a single ring, for example an inner bearing ring or an outer bearing ring. In particular, the invention concerns heating annular bearing components with an induction heater.

### BACKGROUND OF THE INVENTION

Thermal expansion of such annular bearing components induced by induction heating is used, for example, to facilitate the mounting of the bearing on a shaft and/or to obtain an interference fit on the shaft as the bearing cools.

A bearing induction heater heats the annular bearing component until a desired measured temperature of the annular bearing component is reached or until a predefine heating time is reached.

The desired heating time or the desired heating temperature for a particular annular bearing component is generally determined empirically and presented to the user of the induction heater in the form of a reference table. The heating temperature or target temperature is determined accurately based on expansion rate of bearing steel and the required expansion required to overcome the interference fit between the bearing and its shaft, therefore more than 90° C. for regular fitting. The heating time is indeed determined empirically, however reference table are hardly available as too many parameters have strong influence on heating time.

In an embodiment, an induction heater is a device working with a loop in ferrite or in electrical steel in order to circle an annular bearing component and to heat the annular bearing element.

At the same time, an operator can measure the temperature of the annular bearing component with a temperature probe.

However, a yoke of the loop, the temperature probe and the heat resistant gloves of the operator must be carried separately from the induction heater, for example stored in a bag. In order to use the induction heater, the operator must open his bag, bring out the temperature probe, the yoke, the gloves and place one by one the probe and the yoke in the environment of the induction heater.

This procedure is thus long and makes the induction heater not easy to carry and to use.

Consequently, the present invention intends to overcome these disadvantages by providing means to quickly and simply store and use an induction heater and his peripherals, like a yoke, a temperature probe and gloves.

### SUMMARY OF THE INVENTION

One object of the invention is to provide a carry box with integrated induction heater for annular bearing component comprising:

a heater body comprising an induction heater, a top surface to place an annular bearing component, and an inductor comprising two rods protruding outwardly with respect to the top surface,

a top box comprising a bottom tray and a closing lid removably secured to the bottom tray, the bottom tray being removably attached to the heater body and being destined to cover the top surface of the heater body in the attached position, the bottom tray being provided with at least one pocket, the pocket being closed by the closing lid, and

a yoke intended to be stored into the pocket and intended to be placed on the two rods in use.

Advantageously, the bottom tray comprises two through-openings intended to let the rods pass through the bottom tray when the bottom tray is attached to the heater body.

In one embodiment, the carry box comprises an additional yoke intended to be placed on the two rods in use, and the bottom tray comprises an additional pocket to store the additional yoke.

According to an embodiment, the bottom tray comprises a gloves pocket inside which are stored gloves, and a temperature probe pocket inside which is stored a temperature probe.

Advantageously, the carry box comprises two clips intended to attach the bottom tray to the heater body, the two clips being located on two opposite sides of the carry box.

In an embodiment, the heater body comprises a strap fixed at two opposite sides of the carry box.

Advantageously, the material of the top box comprises foam and plastic.

In one embodiment, the closing lid is made with foam, preferably expanded polypropylene, and the bottom tray is made of plastic.

According to an embodiment, the heater body further comprises a user interface area.

Advantageously, the user interface area comprises a display and/or buttons to control the duration and/or the temperature of the heating of an annular bearing component.

### BRIEF DESCRIPTION OF THE DRAWINGS

At least one of the embodiments of the present invention is accurately represented by this application's drawings which are relied on to illustrate such embodiment(s) to scale and the drawings are relied on to illustrate the relative size, proportions, and positioning of the individual components of the present invention accurately relative to each other and relative to the overall embodiment(s). Those of ordinary skill in the art will appreciate from this disclosure that the present invention is not limited to the scaled drawings and that the illustrated proportions, scale, and relative positioning can be varied without departing from the scope of the present invention as set forth in the broadest descriptions set forth in any portion of the originally filed specification and/or drawings. Other advantages and features of the invention will appear from the detailed description of embodiments of the invention, which are non-limiting examples, illustrated on the appended drawing of which:

FIG. 1 is a schematic front view of an embodiment of a carry box in an attached position according to the invention;

FIG. 2 is a schematic front exploded view of the carry box illustrated in FIG. 1; and

FIG. 3 is a top view of a bottom tray of the carry box illustrated in FIG. 1.

### DETAILED DESCRIPTION OF THE INVENTION

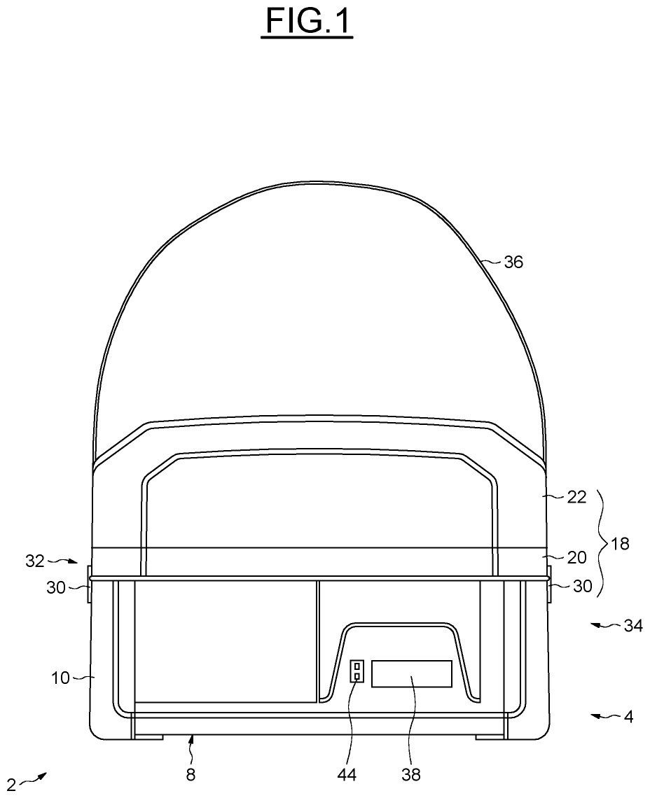

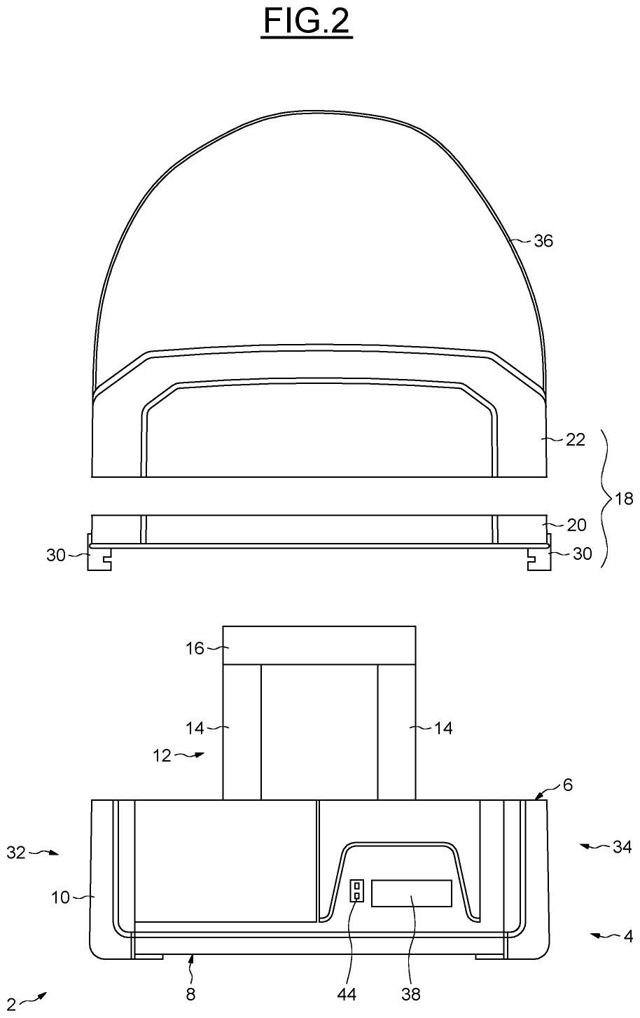

Those of ordinary skill in the art will appreciate from this disclosure that when a range is provided such as (for example) an angle/distance/number/weight/volume/spacing being between one (1 of the appropriate unit) and ten (10 of the appropriate units) that specific support is provided by the specification to identify any number within the range as being disclosed for use with a preferred embodiment. For example, the recitation of a percentage of copper between one percent (1%) and twenty percent (20%) provides specific support for a preferred embodiment having two point three percent (2.3%) copper even if not separately listed herein and thus provides support for claiming a preferred embodiment having two point three percent (2.3%) copper. By way of an additional example, a recitation in the claims and/or in portions of an element moving along an arcuate path by at least twenty (20°) degrees, provides specific literal support for any angle greater than twenty (20°) degrees, such as twenty-three (23°) degrees, thirty (30°) degrees, thirty-three-point five (33.5°) degrees, forty-five (45°) degrees, fifty-two (52°) degrees, or the like and thus provides support for claiming a preferred embodiment with the element moving along the arcuate path thirty-three-point five (33.5°) degrees. As shown in FIGS. 1 and 2, a carry box 2 with integrated induction heater for annular bearing component comprises a heater body 4 comprising an induction heater (not represented), a top surface 6 to place an annular bearing component and a base 8 intended to maintain the carry box 2 in a standard position when the base 8 of the carry box 2 is placed on a flat surface, for example a table or the ground. The heater body 4 also comprises a housing 10, preferably a metallic housing to support the structural assembly and to receive the impacts from the bottom.

In this standard position, the top surface 6, which is parallel to the base 8, is on top of the heater body 2.

The heater body 2 also comprises an inductor 12 in order to generate the heating with the induction heater in an annular bearing component when the annular bearing component is placed around a portion of the inductor 12. The inductor 12 comprises two rods 14 protruding outwardly from the top surface 6. The two rods 14 are parallel to each other and orthogonal to the top surface 6. The inductor 12 may be realized in electrical steel.

The carry box 2 also comprises a yoke 16 intended to be laid on the two rods 14. In particular, the yoke 16 can be removed from the two rods 14 in order to be stored. Yet, the inductor 12 only create a heating induction when the yoke 16 is placed on the two rods 14 so that the inductor 12 and the yoke 16 form a loop, for example a loop of electrical steel. The inductor 12 and the yoke 16 can be realized in ferrite or in electrical steel.

The induction heater comprises a current generator (not represented) in order to generate a current that passes in the loop formed by the yoke 16 and the inductor 12.

The carry box 2 further comprises a top box 18 comprising a bottom tray 20 and a closing lid 22 removably secured to the bottom tray, for example secured by clips.

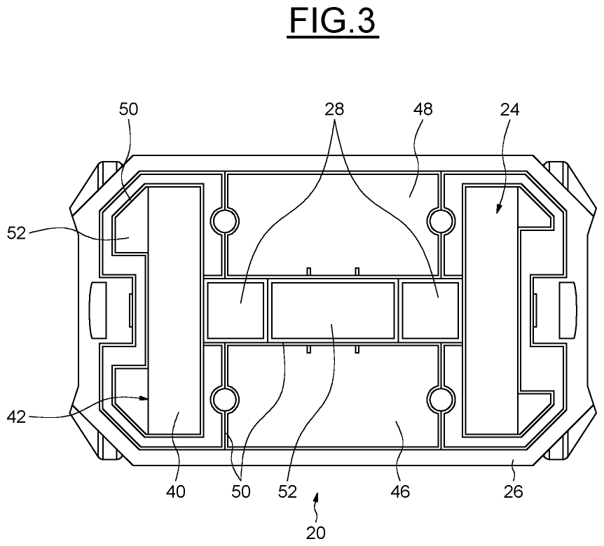

A top view of the bottom tray 20 is represented in FIG. 3.

In particular, the top box 18 is a storage box in which the bottom tray 20 comprises one pocket 24 for the storage of the yoke 16 when not in use. The closing lid 22 allows an operator to close the top box 18 in order to protect the yoke 16 stored inside. When the top box 18 is closed, the closing lid 22 is only in contact with the perimeter 26 of the bottom tray 20. When the closing lid 22 is secured to the bottom tray 20, the pocket 24 is closed.

The material of the top box 18 comprises foam and plastic. In particular, the bottom tray 20 comprises a hard material like plastic in order to be able to maintain the yoke 16 still in the bottom tray 20 without deforming the bottom tray 20. The closing lid 22 comprises foam, preferably sturdy foam. This foam is thus hard and allows a light manipulation by the operator. The foam can be an expanded polypropylene, which has a good resistance to shocks, for example to shocks with a yoke 16 comprising sharp corners. Both closing lid 22 and bottom tray 20 can be molded.

The bottom tray 20 can be removably attached to the heater body 4 and is destined to cover the top surface 6 of the heater body 4 in the attached position.

The bottom tray 20 comprises two through-openings 28 in order to let the two rods 14 pass through the bottom tray 20 when the bottom tray 20 is attached to the heater body 4.

To attach the bottom tray 20 to the heater body 4, the carry box 2 comprises at least two clips 30, the clips being easily removable by an operator to open or close the carry box 2. In one particular embodiment, the two clips are located on two opposite sides 32 and 34 of the carry box 2.

The heater body 4 also comprises a strap 36 also fixed at the two opposite sides 32 and 34 of the carry box 2, preferentially fixed under the clips 30 in the standard position. As a variant, the strap 36 can also be fixed to the top box 18. The strap 36 allows an operator to carry and to transport easily the carry box 2 when placing the strap 36 around his shoulder.

The heater body 4 also comprises a user interface area 38 and a main cable (not represented) for the alimentation of the induction heater.

For example, the user interface area 38 comprises a display and/or buttons to control the duration and/or the temperature of the heating of an annular bearing component. The user interface area 38 may include the possibility to set an automatic stop to the heating when the temperature and/or the duration of the heating has reached a predefined value.

In addition to the user interface area 38, the heater body comprises power button, for example placed on the heater body back side. It allows an operator to turn on or off the induction heater other than unplugging the main cable.

For example, the user interface area 38 is placed on the side face of the heater body 4. In other words, in the standard position when the carry box 2 is placed on a table, the user interface area 38 is placed on the side of the carry box 2.

In one embodiment, the carry box 2 also comprises an additional yoke 40 destined to be laid on the two rods 14 in use. The additional yoke 40 may have different dimensions as the initial yoke 16 in order to create a different power for the heating induction. As a consequence, the bottom tray 20 comprises an additional pocket 42 to store the additional yoke 40.

In the embodiment of the bottom tray 20 illustrated in FIG. 3, several other pockets are integrated in order to carry and store easily other accessories of the carry box 2.

For example, the heater body 4 can display the temperature of a heated annular bearing component. Thus, the heater body 4 comprises a temperature probe connector 44 in order to connect a temperature probe as an accessory to the heater body 4.

The bottom tray 20 further comprises a temperature probe pocket 46 inside which can be stored a temperature probe when not in use.

In addition, the bottom tray 20 also comprises a gloves pocket 48 inside which heat resistant gloves can be stored when not used by the operator. The gloves pocket 48 can be placed between the yoke pocket 24 and the additional yoke pocket 42.

The temperature probe pocket 46 and the gloves pocket 48 can also be used to store other accessories. Furthermore, the bottom tray 20 may comprise additional geometries 50 in order to store other accessories and peripherals in additional pockets 52. The additional geometries 50 may be realized in plastic and foam. Another accessory can be the instructions manual of the carry box, which can be stored in an additional pocket 52 or in the temperature probe pocket 46 or in the gloves pocket 48.

The pockets of the bottom tray 20 make the carry box 2 easy and ready to use without having to extract the accessories from another bag. It allows the operator to spend less time searching and connecting the accessories. During the utilization of the carry box 2, the operator just has to detach the top box 18 from the heater body 4 and to lay the top box 18 next to the heater body 4. Then the operator opens the top box 18 by removing the closing lid 22 and choose the accessories, for example the yoke 16, gloves and a temperature probe. He places an annular bearing component around one rod 14 or around the yoke 16 and then lay the yoke 16 on the two rods 14. The operator can then start the heating with the user interface area 38.

With the bottom tray 20, it is then easier for an operator to access to the accessories all stored in one place, in particular the gloves, the temperature probe and the yokes 16 or 40. Furthermore, there are fewer loosing parts during the heating of an annular bearing component.

1. A carry box with an integrated induction heater for annular bearing component comprising:
a heater body comprising an induction heater, a top surface to place an annular bearing component, and an inductor comprising two rods protruding outwardly with respect to the top surface,
a top box comprising a bottom tray and a closing lid removably secured to the bottom tray, the bottom tray being removably attached to the heater body and being destined to cover the top surface of the heater body in the attached position, the bottom tray being provided with at least one pocket, the pocket being closed by the closing lid, and
a yoke intended to be stored into the pocket and intended to be placed on the two rods in use.

2. The carry box according to claim 1, wherein the bottom tray comprises two through-openings intended to let the rods pass through the bottom tray when the bottom tray is attached to the heater body.

3. The carry box according to claim 1, comprising an additional yoke configured to be placed on the two rods in use, and wherein the bottom tray comprises an additional pocket to store the additional yoke.

4. The carry box according to claim 1, wherein the bottom tray comprises a gloves pocket inside which are stored gloves, and a temperature probe pocket inside which is stored a temperature probe.

5. The carry box according to claim 1, comprising two clips configured to attach the bottom tray to the heater body, the two clips being located on two opposite sides of the carry box.

6. The carry box according to claim 1, wherein the heater body comprises a strap fixed at two opposite sides of the carry box.

7. The carry box according to claim 1, wherein the material of the top box comprises foam and plastic.

8. The carry box according to claim 1, wherein the closing lid is made with foam, preferably expanded polypropylene, and wherein the bottom tray is made of plastic.

9. The carry box according to claim 1, wherein the heater body further comprises a user interface area.

10. The carry box according to claim 9, wherein the user interface area comprises a display and/or buttons to control the duration and/or the temperature of the heating of an annular bearing component.
